(19) United States
(12) Patent Application Publication
(10) Pub. No.: US 2005/0116378 A1
(43) Pub. Date: Jun. 2, 2005

(54) Method for producing shaped bodies

(76) Inventor: Wolfram Lihotzky-Vaupel, Niederalteich (DE)

Correspondence Address: JACOBSON HOLMAN PLLC, 400 SEVENTH STREET N.W., SUITE 600, WASHINGTON, DC, 20004, US

(21) Appl. No.: 10/498,322

(22) PCT Filed: Dec. 12, 2002
(86) PCT No.: PCT/EP02/14186

(30) Foreign Application Priority Data
Dec. 17, 2001 (EP) 01129976.5

(51) Int. Cl. B29C 47/00

(52) U.S. Cl. 264/141; 264/211; 264/143

(57) ABSTRACT

The invention relates to a method of producing molded articles of at least one thermoplastic natural polymer and one small particle comprised natural filler. The melted thermoplastic natural polymer is mixed with the small particle comprised filler to a pasty material mixture and shaped into the molded article. According to the invention it is intended that the small particle comprised natural filler is impregnated and/or wetted with an additive prior to the production of the pasty material mixture.

The invention relates to a method of producing molded articles of at least one thermoplastic natural polymer and one small particle comprised natural filler, wherein the melted thermoplastic natural polymer is mixed with the small particle comprised filler to a pasty material mixture and shaped into the molded article.

Molded articles made from material mixtures that consist to a large extent of natural self-restoring raw materials experience a continuously increasing demand. In particular, molded articles are produced of a thermoplastic polymer, in which the polymer is not a mineral oil product but a natural polymer. Such natural polymers which are produced of plant and/or animal products have been known for a long time.

The invention is based on the object to provide a method of producing molded articles comprising a thermoplastic natural polymer with which molded articles can be produced whose range of application is particularly diverse.

In accordance with the invention the object is solved by a method having the features of claim 1. Advantageous embodiments of the invention are stated in the dependent claims. Starting from a method according to the generic part the invention is characterized in that the small particle comprised natural filler is impregnated and/or wetted with an additive prior to the production of the pasty material mixture.

A basic idea of the invention resides in the fact that a liquid or melted additive provided for a specific usage is not simply incorporated as an additional component into the matrix of the material mixture but that the natural filler is selectively impregnated or wetted with the additive. In this manner specific properties of the small particle comprised natural filler can be adjusted which usually consists of wood chips or another natural fiber.

In principle the method according to the invention can be carried out with all sufficiently known devices for producing molded articles. For instance the material mixture can first be mixed in a separate mixer and afterwards the molding can be carried in a separate press.

However, according to the invention it is particularly economical to carry out the method in an extruder. In the extruder both the mixing process and an injection into a mold, an extrusion by means of a molding tool or a filling into a mechanical stamping or platen press can be performed.

For a particularly economical production of molded articles by means of an extruder it is advantageous to use a double-screw extruder with counter-rotating extruder screws. However, single-screw or multi-screw extruders can also be used and in certain cases a double-screw extruder with screws rotating in the same direction is also possible.

Basically the impregnation or wetting of the small particle comprised filler can be carried out in a separate trough or a separate spraying device prior to the feeding into the extruder. A particularly compact and also economical way of carrying out the method is achieved in accordance with the invention in that the small particle comprised filler is fed into the extruder and the additive is injected into the extruder. Preferably the injection of the liquid additive takes place in a part of the extruder in which the natural polymer has not yet been added to the small particle comprised filler. Since the small particle comprised filler is continuously being rotated by the rotating extruder screws a reliable wetting of the small particle comprised filler can thus be ensured by means of a simple spraying device.

Alternatively it is possible according to the invention that the additive is fed into the extruder in a pulverous state and melted therein, the additive having a melting temperature which is lower than the melting temperature of the natural polymer. This way the pulverous additive can be melted in a first section of the extruder at a first temperature. Due to the rotation of the extruder screws the desired wetting of the melted liquid additive takes place on the surface of the filler particles. In a subsequent section the temperature of the material mixture is raised to a second temperature at which a polymer that has already been mixed with the filler or a polymer that is fed separately is melted. The melted polymer can then enclose the coated or wetted filler particles in order to produce the desired pasty extrusion mass.

In accordance with the invention the additive is a natural oil or wax. These can enclose the fiber and/or be absorbed by it. The fiber is protected thereby is a special way. Thus, when cutting the extruded strands to length or during a machining of the produced molded article it can therefore be prevented that larger surfaces of the fiber are exposed at the cut or machined portions through which moisture might be absorbed. Through a special impregnation with waxes or oils such a moisture absorption by the fibers is counteracted so that moisture that is detrimental to further processing or a premature process of mould growth or rotting is prevented. As a result of the special impregnation of the filler substances or fibers prior to the introduction into the extruder these can also be stored or transported without difficulty for a longer period of time without there occurring a significant absorption of moisture by the filler particles.

Another preferred embodiment of the invention resides in the fact that an additive is used containing a fungus-, bacteria- and/or parasite-stemming property. For this purpose natural ethereal oils that have a desired resistant or parasite-stemming effect are particularly suitable. This protects the molded article and therefore guarantees a long life of the product.

According to the invention it is furthermore advantageous that an additive is used containing a flame-retardant property. This can be a mineral substance. In liquid form the material can be constituted for example by a silicic acid or a siliceous sol that wets the filler particles or penetrates these. Of course, other suitable liquids can also be used through which the flash point of the fibers that are in general easily inflammable is raised considerably. As a result of this treatment of the fibers the flash point of the molded article produced therefrom is likewise raised significantly so that the molded article is no longer inflammable or at least with great difficulty only. In this manner it is possible to produce even insulating boards and other construction materials that have to meet high fire protection requirements with a natural material consisting up to 100 percent of natural raw materials, i.e. that are not produced synthetically. With the method according to the invention it is possible to produce molded articles which meet the requirements of the German fire protection class A2.

With the molding mass produced in this way molded articles of any chosen kind can be produced. The shaping can be implemented through injection into a mold, filling into a mechanical stamping or platen press or extruding through a molding tool to produce profiles, tubes etc. In this manner rails, rods, tubes, carriers, boards etc. can be produced in large quantities in a particularly economical fashion.

In accordance with the invention it is preferred that the molded articles are granules which are produced by means of length cutting when discharged from the extruder. For this purpose a rotating knife can be used as cutting device which is arranged directly at a perforated plate as molding tool.

Another preferred embodiment of the invention resides in the fact that the additive is mixed with the filler to a fiber slurry which is foamed. Here the additive can be selected in order to achieve an improved bonding and foaming of the fiber slurry. As a result both solid and also particularly light molded articles can be produced according to the invention.

For the production of particularly solid molded articles it is advantageous if a thermosetting binder is used as additive. As binder for example water glass or another composition on the basis of water glass or another suitable thermosetting binder can be used. By preference the heating takes place after the discharge of the molded mass from the extruder or mold, with the heating being effected by means of a suitable heating device, in particular by infrared or microwave radiation. The thermosetting binder is adjusted such that the thermosetting temperature is not reached inside the extruder but only after the discharge from the extruder by the special heating device. Thus, molded articles can be produced whose strength is up to ten times higher than that of conventionally produced molded articles.

For the method according to the invention all suitable and known polymers of plant or animal origin that have good bonding properties can be used as thermoplastic natural polymers. In particular starch, grain flours, gelatin, lignins, natural waxes etc. and their components are suitable. Depending on the desired property of the molded article the proportion of natural polymers in the material mixture may range from 10 to 80%. As further components for the material mixture fillers, plastifiers, color pigments as well as other additives can be provided for producing the desired material properties.

The small particle comprised natural filler can be of plant as well as animal origin. Particularly preferred are wood in the form of sawdust and/or fibrous wood such as palm trunks in shredded or dried form, shredded or recycled chip boards, straw stemming from various kinds of corn, reed, bagasse from the sugar cane extraction, grain husks such as rice husks, spelt husks or skins, natural fiber of any kind such as coconut, hemp, flax etc. spent oil seeds, olive oil draff and fruit marc in a dried or undried state. As natural substances of animal origin hair or horn chips can be used. By preference the raw materials are to be processed in a dried form, but they can also be processed at a residual humidity of approximately 25% when special measures are taken such as a repeated degassing for example. The natural fibers can be added in different and/or defined lengths as an additional reinforcement or respectively to increase the bending und tensile strength.

1-12. (canceled)

13. Method of producing molded articles of at least one thermoplastic natural polymer and one small particle comprised natural filler, wherein the melted thermoplastic natural polymer is mixed with the small particle comprised filler to a pasty material mixture and shaped into the molded article, wherein the small particle comprised filler is impregnated and/or wetted with an additive prior to the production of the pasty material mixture.

14. Method according to claim 13, wherein this is carried out in an extruder, a platen press and/or a multiplaten press.

15. Method according to claim 14, wherein the small particle comprised filler is filled into the extruder and the additive is injected into the extruder.

16. Method according to claim 14, wherein the additive is fed into the extruder in a pulverous state and melted therein, the additive having a melting temperature which is lower than the melting temperature of the natural polymer.

17. Method according to claim 13, wherein the dditive is a natural oil or wax.

18. Method according to claim 13 wherein an additive is used containing a fungus-, bacteria- and/or parasite-stemming property.

19. Method according to claim 13, wherein an additive is used containing a flame-retardant property.

20. Method according to claim 13, wherein a thermosetting binder is used as additive.

21. Method according to claim 13, wherein the molded articles are granules which are produced by means of length cutting when discharged from the extruder.

22. Method according to claim 13, wherein as a result of extrusion profiles are being shaped as molded articles.

23. Method according to claim 13, wherein the additive is mixed with the filler to a fiber slurry which is foamed.

24. Method according to claim 13, wherein
the small particle comprised natural filler is fed into the extruder in an unwetted state,
the additive is fed into the extruder separately from the small particle comprised natural filler,
the feeding of the additive into the extruder takes place prior to the introduction of the natural polymer into the extruder,
the small particle comprised natural filler is mixed with the additive in the extruder whereby the small particle comprised natural filler is impregnated and/or wetted with the additive,
in a subsequent section of the extruder the thermoplastic natural polymer is introduced, and
in this section the thermoplastic natural polymer is melted and mixed with the filler that is impregnated and/or wetted with additive.
